(19) United States
(12) Patent Application Publication
(10) Pub. No.: US 2021/0078691 A1
(43) Pub. Date: Mar. 18, 2021

(54) WARM DECORATIVE HARD FLOORING SYSTEM FOR AN AIRCRAFT

(71) Applicant: Gulfstream Aerospace Corporation, Savannah, GA (US)

(72) Inventors: Robert Telmos, Savannah, GA (US); Eric Cox, Savannah, GA (US); Harrison Grantham, Savannah, GA (US); Daniel Condroski, Savannah, GA (US); Mike Lucas, Savannah, GA (US); Kristopher Lynch, Savannah, GA (US)

(73) Assignee: Gulfstream Aerospace Corporation, Savannah, GA (US)

(21) Appl. No.: 16/570,960

(22) Filed: Sep. 13, 2019

(51) Int. Cl. B64C 1/18; E04C 2/36; F24D 13/02; F16F 7/00

(52) U.S. Cl. CPC B64C 1/18; E04C 2/365; B32B 3/12; F16F 7/00; F24D 13/024

(57) ABSTRACT

Exemplary embodiments of a decorative hard flooring system for an aircraft are disclosed herein. The hard flooring system includes a plurality of decorative hard floor assemblies at least some of which include a decorative hard flooring layer and a metallic substrate layer having at least one aperture formed therein to receive a warming element. The flooring system further includes, a power supply coupled to the warming element and a controller coupled to the power supply to control the power supplied to the warming element. An ambient temperature sensor coupled to the controller to provide an indication of ambient temperature so that the controller controls the power supply to power the warming elements to warm the decorative hard floor assemblies to be substantially at the ambient temperature.

### TECHNICAL FIELD

The present invention generally relates to flooring systems for aircraft, and more particularly relates to decorative hard flooring systems for an aircraft that are warmed for the comfort of the aircraft passengers.

### BACKGROUND

Modern business aircraft typically include a well-appointed passenger cabin for the safety and comfort of aircraft passengers. Within the passenger cabin, various areas or compartments are defined which may include an entrance area, a galley, a general seating area, a private seating area or office and a lavatory. Conventionally, flooring for these various areas of the passenger cabin are provided with carpeting suitable to withstand long-term wear. Increasingly however, owners of contemporary business aircraft demand more elegant flooring systems for their aircraft. Typical requests for flooring systems include hardwood flooring, stone flooring or metal flooring that often are custom-made to specifications of the aircraft owner. While more elegant and aesthetically pleasing, a decorative hard flooring system for an aircraft may feel noticeably cooler as compared to carpeted areas of the passenger cabin. This temperature difference may be more pronounced for those passengers traveling without shoes while aboard the aircraft. Additionally, decorative hard flooring may introduce undesirable effects such as the transmission of vibration and noise through the decorative hard flooring due to the rigidity of the hard flooring system.

Accordingly, it is desirable to provide a decorative hard flooring system for an aircraft that is warmed to match surrounding temperatures. It is further desirable that the decorative hard flooring system reduce vibration and noise during flight. Furthermore, other desirable features and characteristics will become apparent from the subsequent detailed description and the appended claims, taken in conjunction with the accompanying drawings and the foregoing technical field and background.

### BRIEF SUMMARY

Exemplary embodiments of a decorative hard flooring system for an aircraft are disclosed herein.

In a first non-limiting embodiment, a flooring system for an aircraft includes a decorative hard floor assembly that includes, but is not limited to, a plurality of decorative hard floor assemblies at least some of which include a decorative hard flooring layer and a metallic substrate layer having at least one aperture formed therein to receive a warming element. The flooring system further includes, but is not limited to, a power supply coupled to the warming element and a controller coupled to the power supply to control the power supplied to the warming element. An ambient temperature sensor coupled to the controller to provide an indication of ambient temperature so that the controller controls the power supply to power the warming elements to warm the decorative hard floor assemblies to be substantially at the ambient temperature.

In a second non-limiting embodiment, a flooring system for an aircraft includes a decorative hard floor assembly that includes, but is not limited to, a plurality of decorative hard floor assemblies at least some of which include a decorative hard flooring layer and a metallic substrate layer having at least one aperture formed therein to receive a warming element. The flooring system further includes, but is not limited to, a power supply coupled to the warming element and a controller coupled to the power supply to control the power supplied to the warming element. A carpet temperature sensor coupled to the controller to provide an indication of adjacent carpet temperature so that the controller controls the power supply to power the warming elements to warm the decorative hard floor assemblies to be substantially at the carpet temperature.

### BRIEF DESCRIPTION OF THE DRAWINGS

The present invention will hereinafter be described in conjunction with the following drawing figures, wherein like numerals denote like elements, and

FIG. 1 is a block diagram illustrating a non-limiting embodiment of a decorative hard flooring system for an aircraft in accordance with the teachings of the present disclosure;

FIG. 2 is a block diagram illustrating another non-limiting embodiment of a decorative hard flooring system for an aircraft in accordance with the teachings of the present disclosure;

FIG. 3 is a side view illustrating a non-limiting embodiment of a segment of a decorative hard flooring system of FIG. 1 and/or FIG. 2 for an aircraft in accordance with the teachings of the present disclosure;

FIG. 4 is a exploded view illustrating the warming element arrangement for the hard decorative flooring assemblies in accordance with the teachings of the present disclosure;

FIG. 5 is a perspective bottom view illustrating how to access the warming elements of FIG. 3 in accordance with the teachings of the present disclosure;

FIG. 6 is a side view illustrating another non-limiting embodiment of a segment of a decorative hard flooring system of FIG. 1 and/or FIG. 2 for an aircraft in accordance with the teachings of the present disclosure; and

FIG. 7 is a side view illustrating another non-limiting embodiment of a segment of a decorative hard flooring system of FIG. 1 and/or FIG. 2 for an aircraft in accordance with the teachings of the present disclosure.

### DETAILED DESCRIPTION

As used herein, the word “exemplary” means “serving as an example, instance, or illustration.” The following detailed description is merely exemplary in nature and is not intended to limit application and uses. Any embodiment described herein as “exemplary” is not necessarily to be construed as preferred or advantageous over other embodiments. All of the embodiments described in this Detailed Description are exemplary embodiments provided to enable persons skilled in the art to make or use the embodiment and not to limit the scope that is defined by the claims. Furthermore, there is no intention to be bound by any expressed or implied theory presented in the preceding Technical Field, Background, Drawings, Summary or the following Detailed Description.

A decorative hard flooring system for an aircraft is disclosed herein. According to fundamental exemplary embodiments of the present disclosure, a decorative floor assembly is warmed to be at substantially the temperature of ambient air or carpeting near the decorative floor assembly. Accordingly, aircraft passengers do not notice a floor temperature difference when moving about the passenger cabin. Additionally, the decorative floor assembly is spaced apart from the aircraft floor and sound damping material is placed in the spaced apart area to significantly reduce the transmission of noise. According to other exemplary embodiments of the present disclosure, a decorative floor assembly is vibrationally isolated from direct contact with the aircraft floor to significantly reduce the transmission of vibration from the aircraft floor to the decorative floor assembly. The sound damping and vibration isolation also provide thermal insulation between the cold floor structure and the decorative floor assembly. A greater understanding of the decorative hard flooring system described above may be obtained through a review of the illustrations accompanying this application together with a review of the Detailed Description that follows.

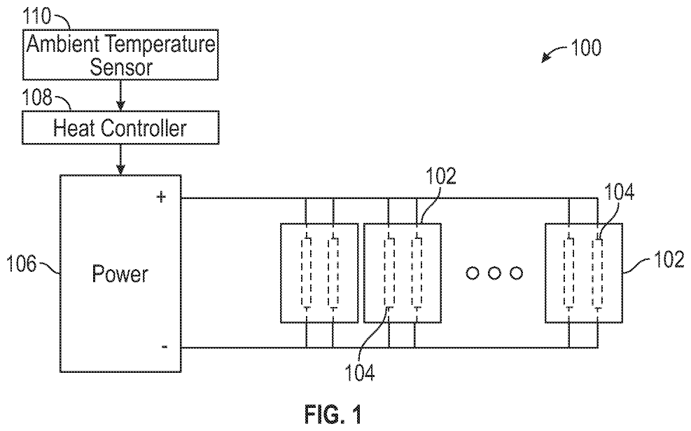

FIG. 1 is a block diagram illustrating a non-limiting embodiment of a decorative hard flooring system 100 in accordance with the present disclosure. The decorative hard flooring system 100 includes a plurality of decorative hard floor assemblies 102 that are positioned or interconnected in any suitable manner to form a floor surface. As will be appreciated by those skilled in the art, hard flooring systems are generally installed in segments (e.g., tiles) of varying shapes and sizes as desired for any particular implementation or design. In some embodiments, the decorative hard floor assembly 102 is configured in 12″×12″ tiles. Other non-limiting examples include hexagonal, octagonal or other tile configurations as may be specified by the aircraft owner.

According to fundamental embodiments of the present disclosure, each floor assembly 102 includes one or more warming (or heating) elements 104 integrated into the floor assembly 102 as will be discussed in more detail below. In the embodiment illustrated in FIG. 1 each floor assembly 102 includes two warming elements 104 which can be arranged to provide even heating across the floor assembly 102 or may be used as a redundant warming element in the events that one warming element fails. As will be appreciated, any number of warming elements or redundant elements may be used in any particular limitation. FIG. 1 illustrates the decorative hard flooring assemblies 102 coupled in a parallel arrangement with a power supply 106. The power supply 106 provides power to each of the individual warming elements 104 under control of the heat controller 108. The heat controller 108 receives as an input a measurement of ambient temperature near the decorative hard flooring system from an ambient temperature sensor 110. The heat controller 108 operates to control each warming element 104 so that its corresponding flooring assembly 102 is warmed to substantially the same as the ambient temperature. As used herein, the phrase “substantially at ambient temperature” means that the temperature of the flooring assembly 102 is at or slightly below the ambient temperature so as not to transmit heat into the passenger cabin of the aircraft. That is, the decorative hard flooring system 100 of the present disclosure does not operate to heat the passenger cabin space, but instead to counteract any perceived temperature difference between the decorative hardwood floor in any adjacent floor surface.

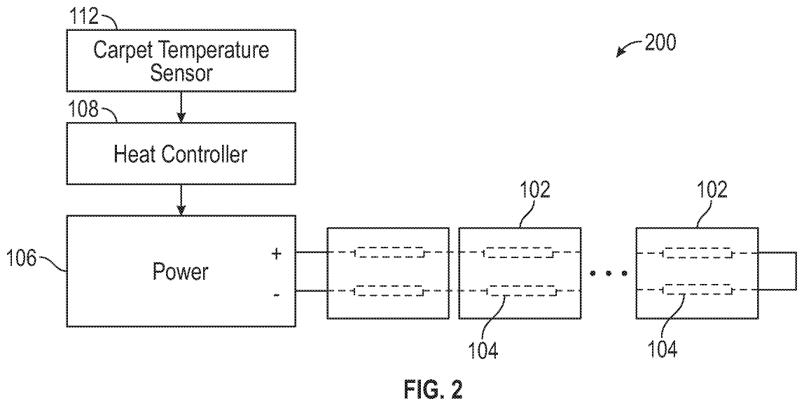

Referring now to FIG. 2, a block diagram is shown illustrating another non-limiting embodiment of a decorative hard flooring system 200 in accordance with the present disclosure. The decorative hard flooring system 200 includes a plurality of decorative hard floor assemblies 102 having their respective integrated warming elements 104 coupled to the power supply 106 in a series arrangement. The decorative hard flooring system 200 operates summarily to the decorative hard flooring system 100 except that the heat controller 108 receives as an input in adjacent carpet temperature provided by carpet temperature sensor 112. Similar to the above, the controller 108 warms the decorative hard floor assemblies 102 to be substantially at the same temperature as carpeting near or adjacent to the decorative hard floor surface. As used herein, the phrase “substantially at carpet temperature” means that the temperature of the flooring assembly 102 is at or slightly below the temperature of adjacent carpeting. Again, the decorative hard flooring system 100 of the present disclosure does not operate to heat the passenger cabin space, but instead to counteract any perceived temperature difference between the decorative hardwood floor in any adjacent carpeting.

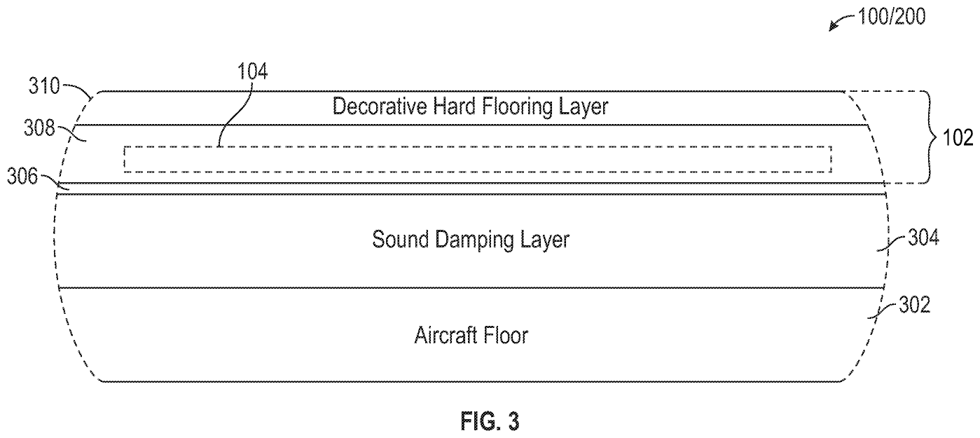

With continued reference to FIG. 1 and FIG. 2, FIG. 3 is a cross-sectional side view illustrating a non-limiting embodiment of a segment of a decorative hard flooring system 100/200 in accordance with the present disclosure. As noted above, hard flooring systems are generally installed in segments (e.g., tiles) of varying shapes and sizes as desired for any particular implementation or design. Such a flooring system promotes ease of installation and serviceability should one or more segments become stained or damaged. As noted above, the decorative hard flooring system 100/200 of the present disclosure is designed to be installed over an aircraft floor 302. As is known by those skilled in the art, an aircraft floor is a structural component that is rigidly fixed to the aircraft fuselage and other structural elements of the aircraft. As such, the aircraft floor experiences various stresses and vibrations during flight of the aircraft. The stresses and vibrations may be caused by the outside air rushing by the fuselage outside skin of the aircraft, turbulence (or other atmospheric conditions), maneuvers performed by the aircraft during flight or engine vibrations transmitted via the fuselage. Accordingly, over the aircraft floor 302 a sound damping layer 304 is positioned to provide sound absorption for noise that may otherwise be transmitted into the passenger cabin. The sound damping layer 304 may be a sound damping felt material or other suitable sound absorbent material as is known in the art. Above the sound damping layer 304, a substrate 306 is positioned below the decorative hard flooring layer 102 and provides a smooth continuous layer to be bonded with the decorative hard flooring layer 102 such as by an adhesive. As used herein, a “decorative hard floor assembly” means a layered arrangement of a decorative hard flooring layer (i.e., the finished surface) and one or more other layers that provide support and strength to the assembly. Depending upon the application, the support and strength provided may be for effective bonding for the decorative flooring layer or stiffness reducing the possibility of damage (e.g., cracking or warping) to the decorative hard flooring layer.

Accordingly, as shown in FIG. 3, the decorative hard floor assembly 102 includes a decorative hard flooring layer 310 that comprises an aesthetically pleasing finished flooring layer selected by the owner of the aircraft. In some embodiments, the decorative hard flooring layer 310 comprises a stone flooring layer, exemplary embodiments of which include granite, marble, quartz, slate, travertine, limestone, soapstone or sandstone. In other embodiments, the decorative hard flooring layer 310 comprises a hardwood flooring layer, exemplary embodiments of which include oak, maple, poplar, walnut, teak, cherry, hickory, pecan, beech or ash. In still other embodiments, the owner of the aircraft may specify a metal flooring material, such as steel, aluminum, stainless steel, titanium or alloys of any of these metal floors. Additionally, porcelain or ceramic flooring material is a common choice for galleys and laboratories. A metallic substrate layer 308, which may comprise aluminum honeycomb panel, has one or more apertures formed therein to receive the warming elements 104 as discussed above. As will be appreciated by those skilled in the art, the decorative hard floor assembly 102 may comprise more or fewer layers, including layers of similar or different materials as desired for any particular implementation.

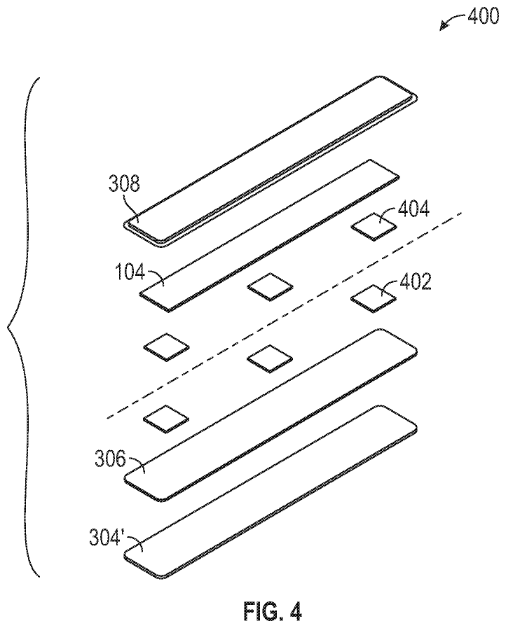

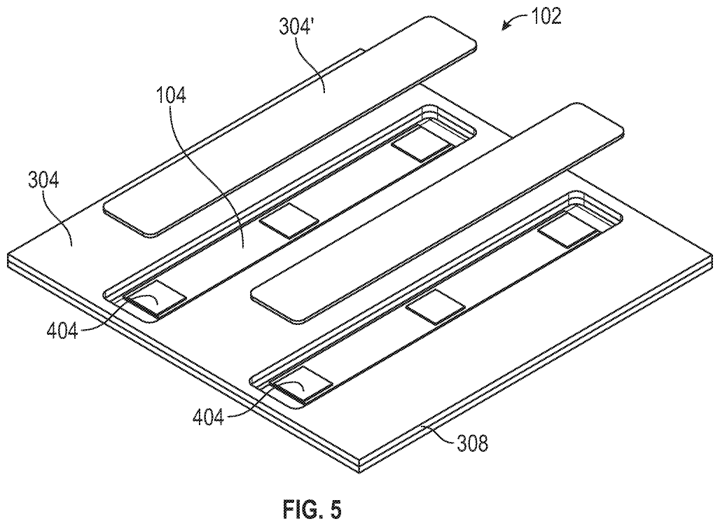

The present disclosure contemplates that the warming elements 104 of the decorative hard flooring assemblies 102 may require service or to be replaced from time to time. Accordingly, the present disclosure contemplates that access can be provided to the warming elements 104 from the underside of the decorative hard flooring assemblies 102. With continued reference to FIG. 3, FIG. 4 illustrates an exploded view 400 showing the metallic substrate layer 308 and the warming elements 104. Coupled to the warming elements 104 is a fastener 404 which may comprise the loop members of a hook-and-loop fastener system. The loop element 402 of the fastening system is coupled to the substrate 306 which in turn is bonded to a removable portion 304 of the sound dampening layer 304. FIG. 5 presents an exploded perspective view of the underside of the decorative hard flooring assembly 102 illustrating how access may be gained to the warming elements 1042 service or replace the warming elements 104.

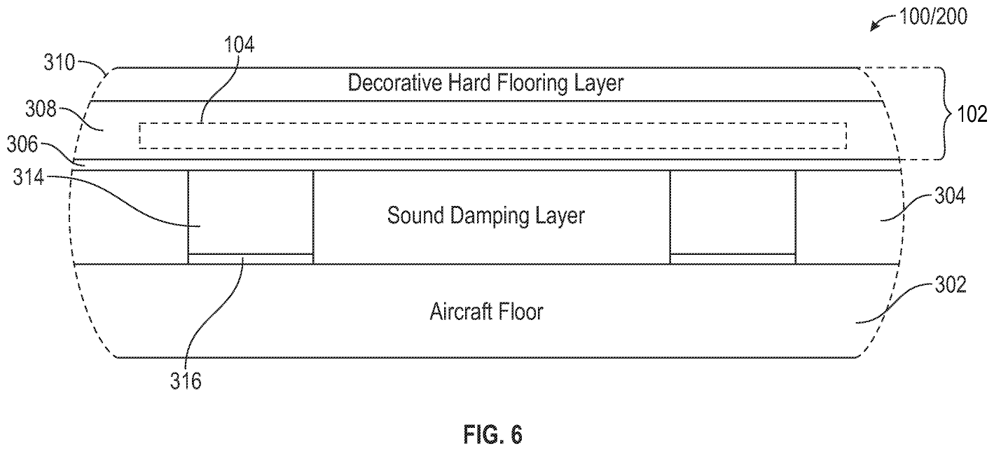

Referring now to FIG. 6, another aspect of the present disclosure is illustrated wherein apertures are formed in the sound damping layer 304 to receive vibration isolators 314. As noted above, the aircraft floor 302 is a structural component that is rigidly fixed to the aircraft fuselage and other structural elements of the aircraft. As such, the aircraft floor experiences various stresses and vibrations during flight of the aircraft. The stresses and vibrations may be caused by the outside air rushing by the fuselage outside skin of the aircraft, turbulence (or other atmospheric conditions), maneuvers performed by the aircraft during flight or engine vibrations transmitted via the fuselage. While the sound damping layer 304 provides effective reduction in noise from traveling from the aircraft floor 302 through the decorative hard flooring assemblies 102 into the passenger cabin, vibrations may still travel from the aircraft floor 302 to cause the decorative hard flooring assembly 102 to vibrate and/or radiate sound in an unappealing manner.

To achieve substantial reduction in the transmission of vibrations from the aircraft floor 302 to the decorative hard floor assembly 102, the present disclosure contemplates isolating the decorative hard floor assembly 102 from the aircraft floor using one or more vibration isolators 314. As used herein, an “vibration isolator” means a discrete and compliant direct contact point between the aircraft floor and the decorative hard floor assembly. By employing a small number of direct contact points with the aircraft floor, vibrations transmitted to the decorative hard flooring system are reduced. Also, the compliant configuration of the vibration isolators absorb a portion of the vibrations, further reducing transmitted vibrations. The vibration isolators 314 limit the number of direct contact points between decorative hard flooring assembly 102 and the aircraft floor 302 as compared to the conventional approach. Moreover, the vibration isolators 314 are comprised of a compliant material that can be selected to absorb or block some of the vibrations that would otherwise be transmitted to the decorative hard floor assembly 102 with direct contact connections. In some embodiments, the vibration isolators 314 have a Durometer Shore A value of approximately 40, although other durometer values may be chosen for any particular implementation. The isolators 314 may be configured to any convenient shape for any given application, including but not limited to, square, rectangular, circular, oval, octagonal or hexagonal. To facilitate installation and servicing of a flooring segment, the present disclosure contemplates a removable fastener 316 (e.g., a hook-and-loop fastener). In the embodiment of FIG. 6, the removable fastener 316 is positioned between the vibration isolator 314 and the aircraft floor 302.

During flight, vibrations impressed upon the aircraft floor 302 will be partially blocked or absorbed by the isolators 314 due to the compliant operation of the isolators 314. Any vibration passing from the isolators 314 to the decorative hard floor assembly 102 are reduced due to the reduced area of contact between the aircraft floor 302, the isolators 314 and the decorative hard floor assembly 102. Accordingly, a passenger standing or walking on the decorative hard flooring layer 310 is less likely to notice vibrations due to the spring-like operation of the isolators 314. As noted above, to combat transmitted noise produced by such vibrations, the sound damping layer 304 operates to absorb noise that would otherwise be transmitted from the aircraft floor 302 into the passenger cabin.

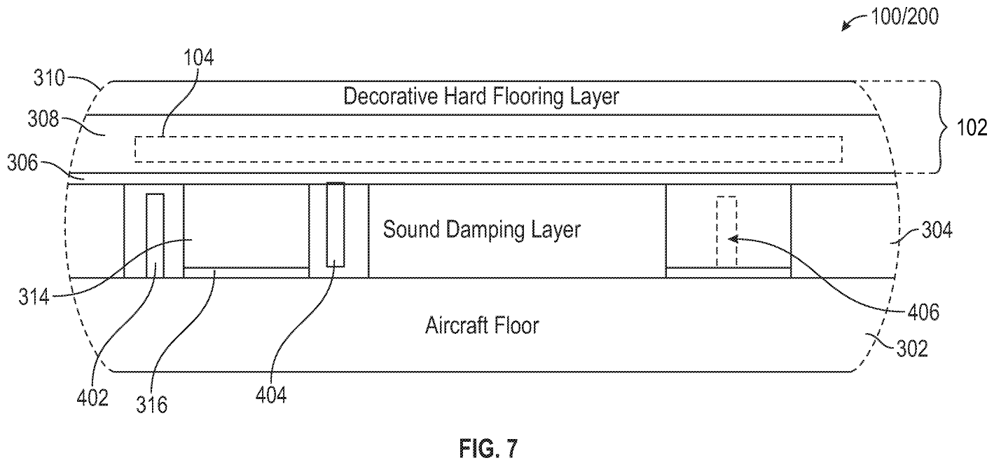

With continued reference to FIG. 6, FIG. 7 is another cross-sectional side view illustrating a non-limiting embodiment of a decorative hard flooring system 100/200 that further incorporates snubbers. As used herein, a “snubber” is a stiff member employed to limit compliant travel (compression) of the isolators 314. In some embodiments, the snubbers limit compliant travel of the isolators 314 beyond 0.1 inches (2.54 millimeters). Depending upon the desired implementation, the snubber may be coupled to the aircraft floor 302 (as shown at 402), or to the decorative hard floor assembly 102 (as shown at 404) or may be integrated into the isolator 314 (as shown at 406). In any event, the use of snubbers provide some flexibility in the durometer chosen for the isolator 314 in that a rigid stop may be provided to prevent compliant travel of the isolator 314 beyond that permitted by the snubber.

It will be appreciated that skilled artisans may implement the described decorative hard flooring systems for an aircraft in varying ways for each particular application, but such implementation decisions should not be interpreted as causing a departure from the scope as set forth in the claims.

In this document, relational terms such as first and second, and the like may be used solely to distinguish one entity or action from another entity or action without necessarily requiring or implying any actual such relationship or order between such entities or actions. Numerical ordinals such as first, second, third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as connect or coupled to that are used in describing a relationship between different elements does not imply that a direct physical connection must be made between these elements. For example, two elements may be connected to each other physically, electronically, logically, or in any other manner, through one or more additional elements.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A flooring system for an aircraft, comprising:
a plurality of decorative hard floor assemblies, at least some of which include:
a decorative hard flooring layer;
a metallic substrate layer disposed between the decorative hard floor layer and an aircraft floor, the metallic substrate layer having at least one aperture formed therein to receive a warming element;
a power supply coupled to the warming element;
a controller coupled to the power supply to control the power supplied to the warming element; and
an ambient temperature sensor coupled to the controller to provide an indication of ambient temperature;
wherein the controller controls the power supply to power the warming elements to warm the decorative hard floor assemblies to be substantially at the ambient temperature.

2. The flooring system of claim 1, wherein the decorative hard flooring layer comprises a stone layer consisting of at least one of the following group of stone flooring material: granite, marble, quartz, slate, travertine, limestone, soapstone and sandstone.

3. The flooring system of claim 1, wherein the decorative hard flooring layer comprises a hardwood layer consisting of at least one of the following group of hardwood flooring material: oak, maple, poplar, walnut, teak, cherry, hickory, pecan, beech and ash.

4. The flooring system of claim 1, wherein the metallic substrate layer comprises a metal layer consisting of at least one of the following group of metal flooring material: steel, aluminum, stainless steel, titanium and alloys of any of the foregoing.

5. The flooring system of claim 4, wherein the metallic substrate layer further comprises a metal honeycomb layer.

6. The flooring system of claim 1, further comprising a sound damping layer disposed between the decorative hard floor assembly and the aircraft floor.

7. The flooring system of claim 6, wherein the sound damping layer having apertures formed therein to receive one or more vibration isolators disposed between the decorative hard flooring layer and the aircraft floor wherein, the decorative hard floor assembly is vibrationally isolated from the aircraft floor thereby reducing transmission of vibrations from the aircraft floor to the decorative hard floor assembly while the sound damping layer reduces transmission of noise from the aircraft floor to the decorative hard floor assembly during flight.

8. The flooring system of claim 7, wherein the one or more vibration isolators comprise compliant isolators having a Durometer Shore A of approximately 40.

9. The flooring system of claim 7, further comprising one or more snubbers positioned between the decorative hard floor assembly and the aircraft floor to limit compliant movement of the one or more isolators.

10. A flooring system for an aircraft, comprising:
a plurality of decorative hard floor assemblies, at least some of which include:
a decorative hard flooring layer;
a metallic substrate layer disposed between the decorative hard floor layer and an aircraft floor, the metallic substrate layer having at least one aperture formed therein to receive a warming element;
a power supply coupled to the warming element;
a controller coupled to the power supply to control the power supplied to the warming element; and
an temperature sensor coupled a carpeted area positioned adjacent to some of the plurality of decorative hard floor assemblies, the controller to provide an indication of carpet temperature;
wherein the controller controls the power supply to power the warming elements to warm the decorative hard floor assemblies to be substantially at the carpet temperature.

11. The flooring system of claim 10, wherein the decorative hard flooring layer comprises a stone layer consisting of at least one of the following group of stone flooring material: granite, marble, quartz, slate, travertine, limestone, soapstone and sandstone.

12. The flooring system of claim 10, wherein the decorative hard flooring layer comprises a hardwood layer consisting of at least one of the following group of hardwood flooring material: oak, maple, poplar, walnut, teak, cherry, hickory, pecan, beech and ash.

13. The flooring system of claim 10, wherein the metallic substrate layer comprises a metal layer consisting of at least one of the following group of metal flooring material: steel, aluminum, stainless steel, titanium and alloys of any of the foregoing.

14. The flooring system of claim 13, wherein the metallic substrate layer further comprises a metal honeycomb layer.

15. The flooring system of claim 10, further comprising a sound damping layer disposed between the decorative hard floor assembly and the aircraft floor.

16. The flooring system of claim 15, wherein the sound damping layer having apertures formed therein to receive one or more vibration isolators disposed between the decorative hard flooring layer and the aircraft floor wherein, the decorative hard floor assembly is vibration isolated from the aircraft floor thereby reducing transmission of vibrations from the aircraft floor to the decorative hard floor assembly while the sound damping layer reduces transmission of noise from the aircraft floor to the decorative hard floor assembly during flight.

17. The flooring system of claim 16, wherein the one or more vibration isolators comprise compliant isolators having a Durometer Shore A of approximately 40.

18. The flooring system of claim 16, further comprising one or more snubbers positioned between the decorative hard floor assembly and the aircraft floor to limit compliant movement of the one or more vibration isolators.

19. The flooring system of claim 18, wherein at least a portion of the one or more snubbers are integrated into one or more vibration isolators.

20. A method of warming a plurality of decorative hard floor assemblies, comprising:
sensing a temperature near plurality of decorative hard floor assemblies; and
controlling a power supply using the temperature to provide power to warming elements integrated within at least some of the plurality of decorative hard floor assemblies;
whereby the decorative hard floor assemblies are warmed to be substantially at the temperature.
